(19) United States
(12) Patent Application Publication
(10) Pub. No.: US 2007/0119007 A1
(43) Pub. Date: May 31, 2007

(54) Tube cleaning apparatus

(76) Inventor: Gerald Minshall, Alcester (GB)

Correspondence Address: PAUL E MILLIKEN, 9061 WALL STREET, NW, MASSILLON, OH, 44646-1676, US

(21) Appl. No.: 11/595,711

(22) Filed: Nov. 10, 2006

(30) Foreign Application Priority Data
May 6, 2005 (GB) PCT/GB05/01741
May 11, 2006 (GB) GB 0410434.5

(51) Int. Cl. B08B 9/04

(52) U.S. Cl. 15/104.09; 15/104.12; 15/104.095

(57) ABSTRACT

A tube cleaning assembly (10) comprising a cylindrical housing (11) having a bore (20) with a coaxial strut (27) therein, capable of both axial and rotation movement relative to the housing (11). One end of the strut (27) extends through an aperture (29) in an end wall (21) of the housing (11) and is connected to a cleaning brush (17), the other end of the strut (27) being adjacent a piston (26) reciprocable within the bore (11) to move the strut axially, the axial movement of the strut (27) being translated into rotational movement around its axis and rotating both strut and brush.

### FIELD OF THE INVENTION

This invention relates to apparatus for cleaning the residue from the bores of thermal transfer tubes.

### BACKGROUND OF THE INVENTION

The inner surfaces of a heat transfer tube may be enhanced with a plurality of surface effects that create additional paths for fluid flow within the tube and thereby enhance turbulence of heat transfer mediums flowing within the tube. This increases fluid mixing to reduce the boundary layer build-up of the fluid medium close to the inner surface of the tube, such build-up increasing the resistance and thereby impeding heat transfer. Known surface effects may be in the form of internal ribs as is shown in EP-A-0865 838, or may be created by a cross-grooved surface as is known from U.S. Pat. No. 6,026,892. These protrusions also provide extra surface area for additional heat exchange. Another method of creating protrusions is shown in WO 03104736

A problem associated with heat exchangers is that over time the bore and exterior walls of the heat exchange tubes develop corrosion, scale and other undesired residue. The build up of residue decreases and/or generally adversely effects the heat transfer efficiencies and operating costs for fuel, in turn, increase. Periodic maintenance is therefore required to clean the tubes. Frequently the equipment must be taken off-line during maintenance. Such maintenance can be performed by plant personnel or outside contractors who are specially trained and use special purpose equipment to perform such tasks. It is desirable that any down time be minimized. The task is typically performed manually and is therefore costly and time consuming, especially for large heating and cooling plants.

A variety of techniques and types of equipment have been developed to clean the interior and exterior surfaces of pipes and particularly heat transfer tubes. One known cleaning technique is to individually direct equipment into each tube to mechanically dislodge the residue from the internal tube walls. Some of the latter equipment uses rigid lances that either rotate and/or have rotating blades. U.S. Pat. No. 5,579,726 discloses a lance-based assembly that directs streams of high-pressure water to effect the cleaning. High-pressure spray systems are also known that direct streams of water from a spray hose into each tube such a system is disclosed in U.S. Pat. No. 6,626,195. Yet another method is disclosed in U.S. Pat. No. 4,676,301 in which a brush element is passed through a heat exchange tube.

The present invention is related to the use of brush cleaning elements for the internal cleaning of heat transfer tubes and in particular to cleaning of tubes having internal surface effects to increase turbulence. A problem with the use of brushes is that when passed through the tubes in a single direction, any residue, scale etc. may only be properly removed from one side of the particular surface effect.

The present invention provides an improved cleaning brush assembly for use within thermal transfer tubes.

### STATEMENTS OF THE INVENTION

Accordingly the invention provides a tube cleaning assembly comprising a cylindrical housing having a bore therein, a strut mounted coaxially within the bore and being capable of both axial and rotational movement relative to the housing, one end of the strut extending through an aperture in an end wall of the housing and being connected to a cleaning brush, the other end of the strut being adjacent a piston reciprocal within the bore to move the strut in at least one axial direction, and wherein axial movement of the strut is translated into rotational movement of the strut and brush, the direction of rotation of the strut and brush being dependant upon the direction of axial movement.

The movement of the brush in two axial directions and both directions of rotation ensures efficient cleaning of the inner surface of the thermal transfer tube.

Preferably the strut is moved in said one axial direction by high pressure cleaning fluid acting upon the piston. The strut is moved in said other axial direction by a spring means, preferably a coil spring located concentrically with the strut and acting between the housing and an abutment means on the strut.

Preferably, the axial movement of the strut within the housing is translated into rotation by axially extending helical surfaces on one of the strut or end wall engaging with a cooperating surface on the other of the strut and end wall. The helical surface may be provided by a helical groove, preferably a single start screw thread. The helical groove may be formed on the strut, and the co-operating surface comprises abutment means on the end wall which engage with the groove.

The abutment means comprise a plurality of abutments circumferentially spaced around the aperture in the end wall. Preferably the abutment means are balls rotatably mounted in the end wall engaging a co-operating screw form in the strut.

The end portion of the strut adjacent the piston is mounted for rotation in a bearing.

The housing is provided with a plurality of spaced holes therein which in use permit cleaning fluid to pass through the housing into the interior of a tube being cleaned.

A tube clamping assembly may be attached to the housing on the pressurized fluid side of the piston, the clamping assembly being operated by cleaning fluid pressure.

Another aspect of the invention provides a method of cleaning the inner surface of a thermal transfer tube in which a tube cleaning assembly according to the first aspect of the invention is passed through the tube in one direction wherein the assembly is causes to pause at spaced locations along the tube and when the assembly is stationary the brush is caused to reciprocate within the tube to move axially and rotationally in first one direction and then in the other direction.

Preferably, the movement in one direction is caused by high pressure cleaning fluid acting on the piston, and movement in the other direction is under a spring bias when said fluid pressure is cut.

### BRIEF DESCRIPTION OF THE DRAWING

The Invention will be described by way of example only and with reference to the accompanying drawings in which:

FIG. 1 is a longitudinal section through a cleaner assembly according to the present invention, and

FIG. 2 is an exploded isometric drawing of the cleaner assembly shown in FIG. 1

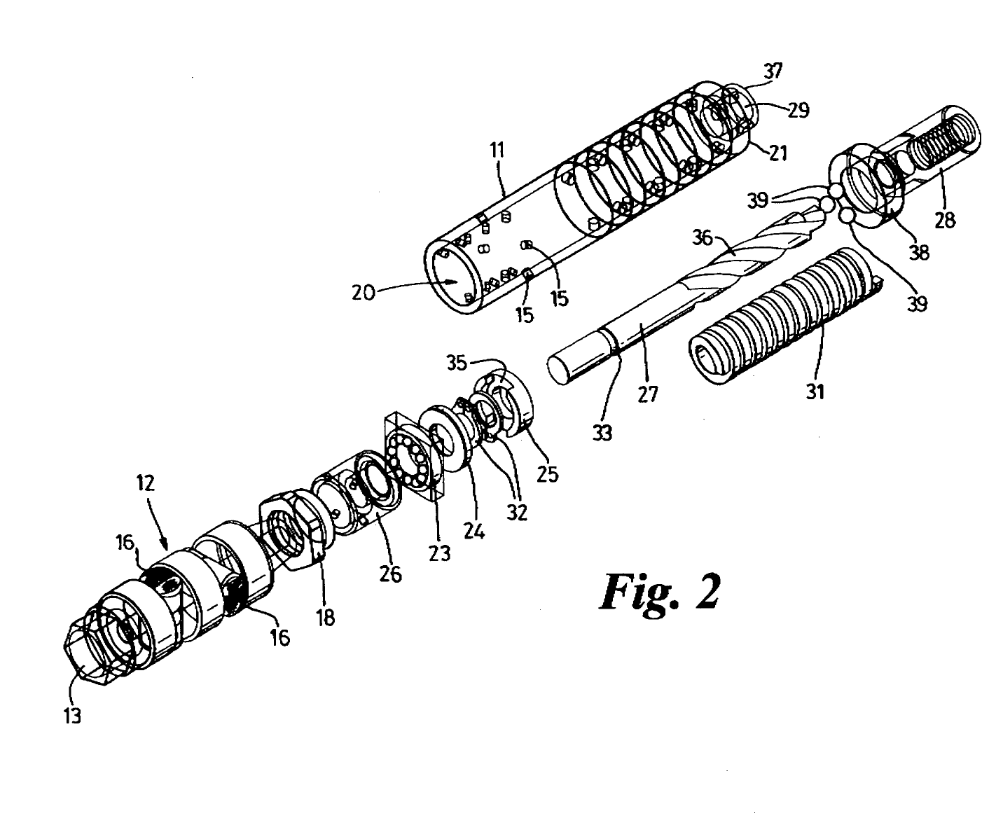

### DETAILED DESCRIPTION OF THE INVENTION

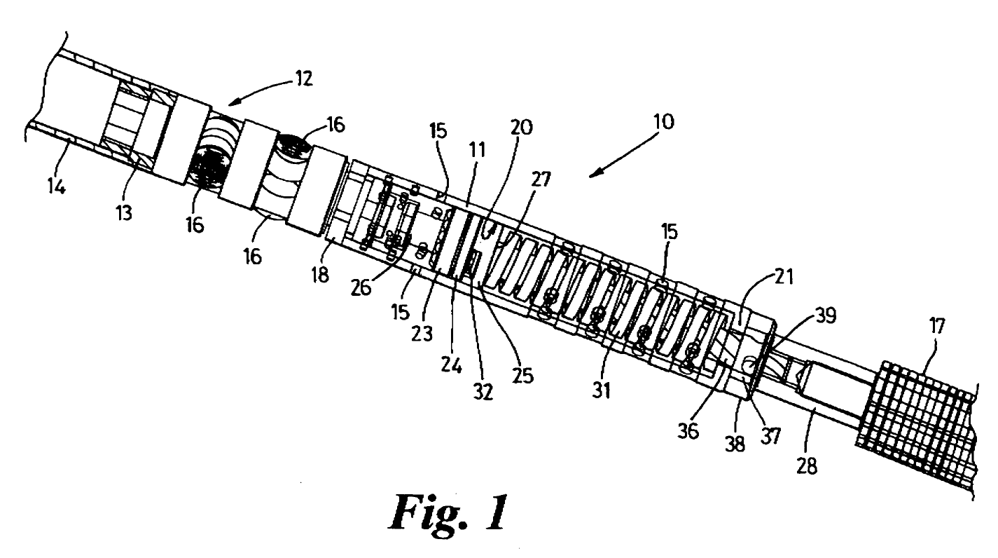

A cleaner assembly 10 for cleaning the internal surface of a thermal transfer tube is shown in FIGS. 1 & 2. The assembly 10 comprise a cylindrical housing 11 having a bore 20 closed at one end by a rear sub-assembly 12 and at its other end by an end wall 21.

The rear sub assembly 12 is cylindrical and has a connection 13 to a supply hose 14. The supply hose 14 is connected to a pump (not shown) for the supply of high pressure water into the cleaner assembly 10. The rear sub-assembly may further include radially moveable pins 16 which in use are move by fluid pressure into contact with the inner surface of a tube to hold the cleaner assembly fast during the operation of a cleaning brush 17 mounted at the other end of the housing. An annular plate 18 at the front end of the sub-assembly engages with the rear of the cylindrical housing 11 to form an end wall of the housing. The plate 13 may be assembled to the housing 11 using co-operating screw threads.

A suitable length of hose 14 is secured to the cleaner assembly 10 and is typically deployed and stored at a hose spool or collection reel assembly. The hose 14 is constructed to withstand the normal anticipated working conditions and pressures and is typically constructed of several layers of water impermeable material in numerous wound wrappings and may contain wraps or bands of wire, KEVLAR and the like. The diameter of the hose 14 can be selected as desired e.g 3 mm to 25.00 mm depending upon the application, diameter of tube to be cleaned and desired working pressures.

The housing 13 has a desired number of orifices 15 spaced at desired locations around the housing to direct a number of high-pressure (e.g. 200 to 50,000 psi) streams of water against the internal walls of a heat transfer tube to dislodge and wash scale and residue from the tube walls.

A piston 26 is located in the bore 20 adjacent the rear sub-assembly 12 and is capable of reciprocating movement within the bore. Pressurized fluid entering the housing 11 acts on the piston 26 to push the piston away from the end wall 18. An annular bearing 23, preferably a ball race, is located adjacent the front face of the piston 26 with an annular thrust washer 24 located on the side of the bearing 23 away from the piston.

A coaxial annular strut 27 extend axially from the piston 26 and passes through an aperture 29 in the front end wall 21 to join with a connector 28 in turn connected to the brush 17. The strut 27 is held coaxially within the housing 11 by an annular spacer 25 adjacent the thrust washer 24 and passes through the centres of the spacer 25, thrust washer 24 and bearing 23 for contact with the piston 26.

A coil spring 31 is arranged coaxially of the strut 27 and acts between the front end wall 21 of the housing 11 and the spacer 25 which in turn abuts a pair of circlips 32 which engage in a groove 33 in the end portion of the strut 27 adjacent the piston. The spring 31 biases the strut rearwardly of the housing. The circlips 32 are accommodated in a recess 35 formed in the face of the spacer 25 adjacent the thrust bearing 24.

The other end portion of the strut 27 has a helical groove 36 formed thereon. The grooved portion of the strut 27 passes through the aperture 29 in the end wall 21. The end wall 21 has a central spigot 37 projecting axially outwardly of the housing 11 and a ball ring 38 is located on the outer side of the end wall around the spigot 37. The ball ring 38 provides a housing for a plurality of ball 39, preferably three, which pass through apertures in the spigot to engage in the helical groove 36. The groove 36 is a single lead helical groove and the balls 39 are axially off-set engaging in different locations along the groove.

With the cleaner assembly in position within a tube, when cleaning fluid, typically water, is introduced under pressure through the rear sub-assembly 12. The supply of pressurised water and movement of the cleaner assembly along the tube may be controlled by a pre-programmed cleaning apparatus that forms no part of the present invention.

The water pressure causes the pins 16 to move radially outwardly to engage the sides of a tube. The piston 26 is moved forward by the pressure to move the strut 27 axially forward. The strut 27 is free to rotate on the bearing 23 and ball ring 38, and therefore the forward movement of the strut 27 coupled with the engagement of the balls 39 in the helical groove 36, translates the axial movement onto both axial and rotational movement of the strut 27. The movement of the strut 27 in turn causes the brush 17 to move forward and rotate in one direction of rotation. Water under pressure will also pass through orifices 15 which direct the jetted streams of water against the tubing.

If the pressurized water feed is cut, the spring 31 pushes the strut 27 rearward and the brush is caused to rotate in the opposite direction of rotation. The rearward movement of the piston 26 under the spring load will cause water in the housing to be displaced out through the orifices 25.

Although, the piston (26) is conveniently moved forwardly by the hydraulic pressure generated by the cleaning fluid, the piston may be advanced by mechanical means (not shown) such as an actuator.

The reciprocating brush stroke will typically be between ½-1.0 inch (12-25 mm) and the cleaning assembly advances through the tube in a series of steps cleaning by reciprocation of the brush at each step.

In other embodiments of the present invention (not shown) the clamping pins 16 may be omitted. The brush may be advanced through the tube by mechanical means, for example by pushing the hose (14) into the tube. Multiple lead helical grooves may be used instead of the single lead helical groove 36.

The combination of rotational and axial movement of the brush in two directions ensures that any surface grooving, or ribbing is cleaned on both axial sides as the brush reciprocates within the tube. The brush assembly according to the present invention is therefore capable of cleaning both sides of a surface effect within the tube for a single pass of the assembly along the tube in one direction only.

What is claimed is:

1. A tube cleaning assembly comprising a cylindrical housing having a bore therein, a strut mounted coaxially within the bore and being capable of both axial and rotation movement relative to the housing, one end of the strut extending through an aperture in an end wall of the housing and being connected to a cleaning brush, the other end of the strut being adjacent a piston reciprocable within the bore to move the strut in at least one axial direction, and wherein axial movement of the strut is translated into rotational movement around its axis to rotate the strut and brush, the direction of rotation of the brush being dependant upon the direction of axial movement.

2. A cleaning assembly as claimed in claim 1 wherein the brush is moved in said one axial direction by high pressure cleaning fluid acting upon a face of the piston.

3. A cleaning assembly as claimed in claim 2, wherein the brush is moved in said other axial direction by a spring means acting between the housing and abutment means on the strut.

4. A cleaning assembly as claimed in claim 3 wherein the spring means is a coil spring coaxial with the strut.

5. A cleaning assembly as claimed in claim 1, wherein the axial movement of the strut within the housing is translated into rotational movement by axially extending helical surfaces on one of the strut or end wall engaging with at least one co-operating abutment surface on the other of the strut and end wall.

6. A cleaning assembly as claimed in claim 5 wherein the helical surface may be provided by a helical groove.

7. A cleaning assembly as claimed in claim 6 wherein the helical groove is a single start helical groove.

8. A cleaning assembly as claimed in claim 7, wherein the helical groove is formed on the strut.

9. A cleaning assembly as claimed in claim 8 wherein the co-operating surface comprise abutment means on the end wall which engage with the groove.

10. A cleaning assembly as claimed in claim 5, wherein the abutment surfaces are provided on a plurality of circumferentially spaced abutments.

11. A cleaning assembly as claimed in claim 10, wherein the abutment means are balls rotatably mounted in the aperture in end wall and engage with a co-operating screw form in the strut.

12. A cleaning assembly as claimed in claim 1, wherein the housing is provided with a plurality of spaced holes therein which in use permit cleaning fluid to pass through the housing into the interior of a tube being cleaned.

13. A cleaning assembly as claimed in claim 1, wherein a tube clamping assembly is provided for attachment to the housing on the pressurized fluid side of the piston, the clamping assembly being operated by cleaning fluid pressure.

14. A method of cleaning the inner surface of a thermal transfer tube in which a tube cleaning assembly according to claim 1, is passed through the tube in one direction wherein the assembly is caused to pause at spaced locations along the tube and when the assembly is stationary the brush is caused to reciprocate within the tube to move axially and rotationally in first one direction and then in the other direction.

15. A method as claimed in claim 14 wherein movement in one direction is caused by high pressure cleaning fluid acting on the piston, and movement in the other direction is under a spring bias when said fluid pressure is cut.

16. A method as claimed in claim 15, wherein cleaning fluid jets through the housing as the brush is rotated.
